(19) United States
(12) Patent Application Publication
(10) Pub. No.: US 2007/0061956 A1
(43) Pub. Date: Mar. 22, 2007

(54) Handheld bidet

(76) Inventors: Shih-Kuei Yu, Nantour Hsien (TW); Cheng-Wei Yu, Nantour Hsien (TW); Tze Shin Yu, Nantour Hsien (TW)

Correspondence Address: PATENTTM.US, P. O. BOX 82788, PORTLAND, OR, 97282-0788, US

(21) Appl. No.: 11/233,155

(22) Filed: Sep. 21, 2005

(51) Int. Cl. A47K 3/26; A47K 3/022; A61H 35/00

(52) U.S. Cl. 4/443

(57) ABSTRACT

A handheld bidet has a body, a valve and a cleaning nozzle. The body has a tubular body and a valve seat. The body has a fluid channel defined through it. The valve seat is defined in a sidewall of the body communicating with the fluid channel. The valve is mounted inside the valve seat in the body to control the water flow. The cleaning nozzle is mounted on a bent distal end of the body to spray water. A lip is formed on the outer surface of the cleaning nozzle and multiple through holes defined in the cleaning nozzle. To use the handheld bidet, the body is connected to a faucet. Water passes from the through holes in the cleaning nozzle to clean the anus. In addition, users may use the lip formed on the cleaning nozzle to aid in cleaning.

### BACKGROUND OF THE INVENTION

1. Field of the Invention

The present invention relates to a handheld bidet, more particularly to a handheld bidet that is convenient to use.

2. Description of the Related Art

People throughout time have always had to deal with the problem of cleaning up after defecation. The most common method is the use of toilet tissue, which is usually not the most hygienic. It is also not the most efficient or comfortable means for those suffering from maladies such as hemorrhoids, anal fissures, inflammation or diarrhea. Women also experience similar hygiene dilemmas during menstruation. Hence, a personal handheld cleanser has been produced and is available on the market. However, the personal handheld cleanser has the following disadvantages:

1. The handheld cleanser has a cleaning nozzle and a container for storing water. The limited amount of water stored in the cleanser is usually insufficient for thorough cleaning and often requires refilling during use.

2. The cleaning nozzle of the handheld cleanser is usually linear in form and not quite ergonomic, so the conventional handheld cleanser is not convenient to use.

3. The spray from the handheld cleanser is in the form of a stream of water, which is ineffective for complete cleaning.

4. When pressure on the handheld cleanser is released, the container returns to its original form and draws water back through the cleaning nozzle and back into the container, which can cause contamination.

Therefore, the invention provides a handheld bidet to mitigate or obviate the aforementioned problems.

### SUMMARY OF THE INVENTION

The primary objective of the present invention is to provide a handheld bidet that is convenient to used and provides multiple functions.

A handheld bidet in accordance with the present invention has a body, a valve and a cleaning nozzle. The body has a tubular body and a valve seat. The body has a fluid channel defined through it. The valve seat is defined in a sidewall of the body communicating with the fluid channel. The valve is mounted inside the valve seat in the body to control the water flow. The cleaning nozzle is mounted on a bent distal end of the body to spray water. A lip is formed on the outer surface of the cleaning nozzle and multiple through holes are defined in the cleaning nozzle.

To use the handheld bidet, the body is connected to a faucet. Water passes through the through holes in the cleaning nozzle to clean the rectal area. In addition, users may use the lip formed on the cleaning nozzle to aid in cleaning.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a handheld bidet in accordance with the present invention;

FIG. 2 is a front view in partial section of the handheld bidet in FIG. 1;

FIG. 3 is an enlarged side view of the handheld bidet in FIG. 1, showing the operation of the valve;

FIG. 4 is an enlarged side view of a cleaning nozzle of the handheld bidet in FIG. 1; and

FIG. 5 is an operational perspective view of the handheld bidet in FIG. 1.

### DETAILED DESCRIPTION OF THE INVENTION

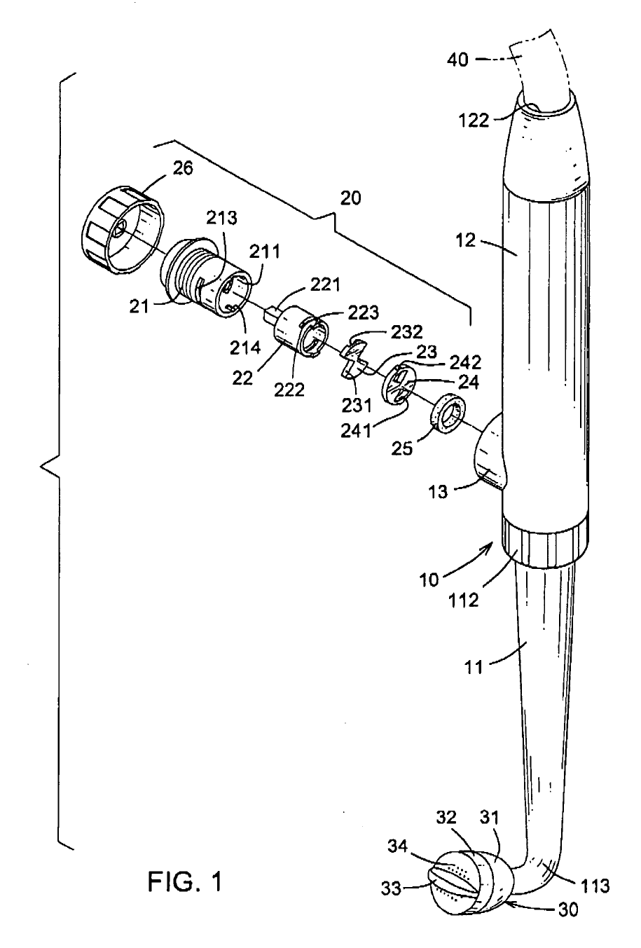

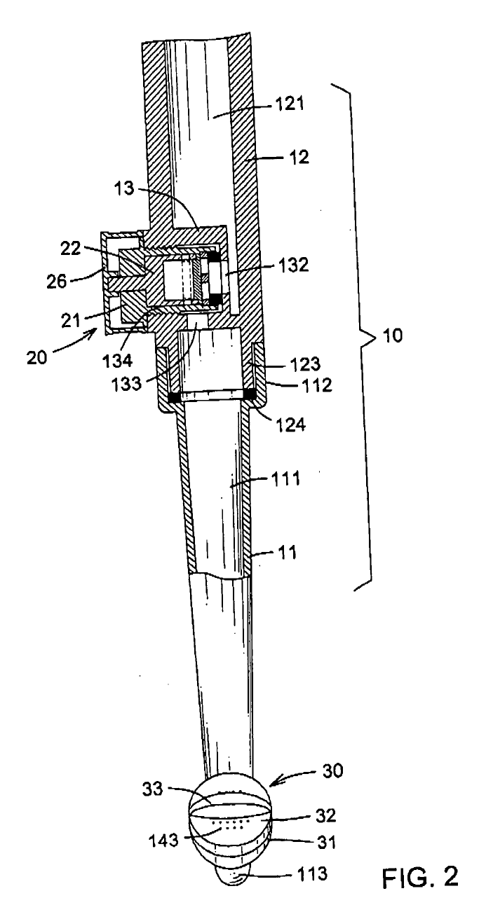

With reference to FIGS. 1 and 2, a handheld bidet in accordance with the present invention has a body (10), a valve (20), a cleaning nozzle (30) and an optional shower hose (40).

The body (10) has a tubular body and a valve seat ( 13). The body has a bent distal end, a proximal end, a sidewall and a fluid channel. The valve seat (13) is defined in the sidewall of the tubular body and communicates with the fluid channel in the body (10). In a preferred embodiment, the body (10) has a spray tube (11) and a handle tube (12).

The spray tube (11) is mounted on the handle tube (12) and has a distal end (113), a proximal end (112) and a channel (111). The proximal end (112) of the spray tube (11) is connected to the handle tube (12). The channel (111) is defined through the spray tube (11). The distal end (113) of the spray tube (11) is bent.

The handle tube (12) has a distal end (123), a proximal end (122), a sidewall, a fluid channel (121) and a washer (124). The distal end (123) of the handle tube (12) is connected to the proximal end (112) of the spray tube (11), and the proximal end (122) of the handle tube (12) may be connected to a shower hose (40). The fluid channel (121) is defined through the handle tube (12). The washer (124) is mounted between the proximal end (112) of the spray tube (11) and the distal end (123) of the handle tube (12) to prevent water leakage.

The valve seat (13) is cylindrical and defined in the sidewall of the handle tube (12). The valve seat (13) communicates with the fluid channel (121) in the handle tube (12) near the distal end. The valve seat (13) has a side surface, a cavity (131), an inlet (132), an outlet (133) and a threaded end (134). The cavity (131) is defined in the valve seat (13). The inlet (132) and the outlet (133) are defined respectively in two side surfaces of the valve seat (13) and communicate with the fluid channel (121) in the handle tube (12). The outlet (133) is located near the proximal end (123) of the handle tube (12). The threaded end (134) is defined in a side surface and near the sidewall of the handle tube (12).

The valve (20) is mounted inside the valve seat (13) in the body (10) to control the water flow. In a preferred embodiment, the valve (20) is mounted inside the handle tube (12) and has a valve body (21), a valve center (22), a blocking plate (23), a plate (24), a washer (25) and a knob (26).

The valve body (21) is mounted inside the valve seat (13) and has an inner end, an outer end, an outer surface, a cavity (211), a through hole (212), multiple fluid channels (213) and two engaging grooves (214). The inner end of the valve body (21) is mounted inside the cavity (131) in the valve seat (13). The outer end extends from the valve seat (13). The cavity (211) is defined in the valve body (21) at the inner end. The through hole (212) is defined in the valve body (21) to communicate with the cavity (211) and is at the outer end. The fluid channels (213) are defined through the outer surface of the valve body (21). The two engaging grooves (214) are defined in the inner surface of the valve body (21) at the inner end and face each other.

The valve center (22) is rotatably mounted inside the valve body (21) and has an inner end, an outer end, an outer surface, a rod (221), an opening, multiple fluid channels (222) and multiple teeth (223). The rod (221) is formed on the outer end of the valve center (22). The opening is defined in the inner end of the valve center (22). The fluid channels (222) are defined through the outer surface of the valve center (22) and can be aligned to correspond with the fluid channels (213) in the valve body (21). The teeth (223) are formed at the inner end. In a preferred embodiment, two teeth (223) are formed and are opposite each other.

The blocking plate (23) is mounted at the inner end of the valve center (22) and has an edge, an inner surface, two breaches (231) and two grooves (232). The inner surface faces the cavity in the valve center (22). The breaches (231) are defined in the edge of the blocking plate (23) and opposite to each other. The grooves (232) are defined in the inner surface and correspond with the teeth (223) on the valve center (22).

The plate (24) is mounted at the inner end of the valve center (22) outside of the blocking plate (23). The plate (24) has an edge, two flow through holes (241) and two locating studs (242). The flow through holes (241) are defined in the plate (24). The locating studs (242) are formed on the edge and corresponds with the engaging grooves (214) in the valve body (21).

The washer (25) is mounted between the valve seat (13) and the plate (24) to prevent water leakage.

The knob (26) is mounted onto the rod (221) at the outer end of the valve body (21). Twisting the knob (26) will rotate the valve center (22) within the valve body (21).

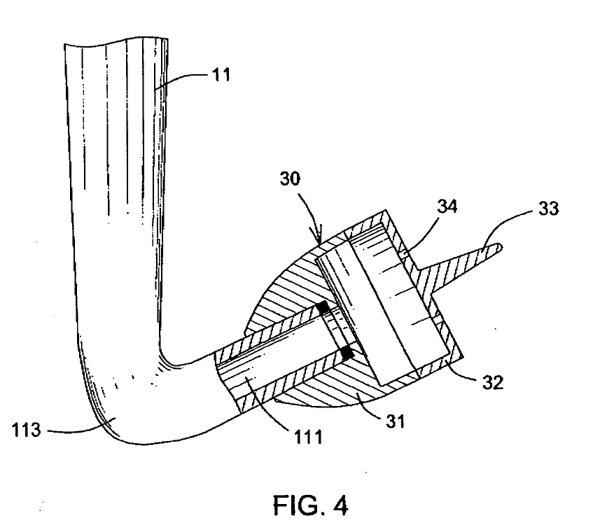

With reference to FIG. 4, the cleaning nozzle (30) is mounted on the bent distal end (113) of the body (10) and has an inner surface, an outer surface, a lip (33) and multiple through holes (34). The lip (33) is formed on the outer surface of the cleaning nozzle (30). The multiple through holes (34) are defined in the cleaning nozzle (30). In a preferred embodiment, the cleaning nozzle (30) is mounted on the spray tube (11) and has an inner chamber, a casing (31) and a cap (32). The casing (31) is connected to the distal end (113) of the spray tube (11). The cap (32) is mounted on the casing (31) and the inner chamber is formed between the casing (31) and the cap (32). The cap (32) has an inner surface and an outer surface. The lip (33) is formed on the outer surface of the cap (32) and is fan-shaped. The multiple through holes (34) are defined in the cap (32) to communicate with the inner chamber in the cleaning nozzle (30).

The shower hose (40) is mounted on the proximal end (122) of the handle tube (12).

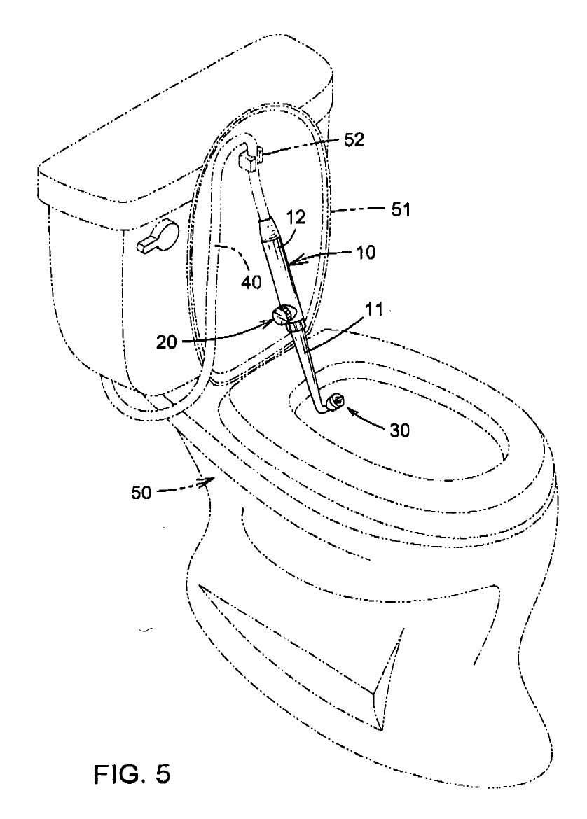

With reference to FIGS. 1 and 5, the handheld bidet in accordance with the present invention may be connected to the water tank of a toilet (50) directly or to a conventional faucet (not shown) for use. When the handheld bidet is used with the toilet (50), the toilet (50) may have a hook (52) mounted on the lid (51) of the toilet seat (not numbered) to hold the handheld bidet.

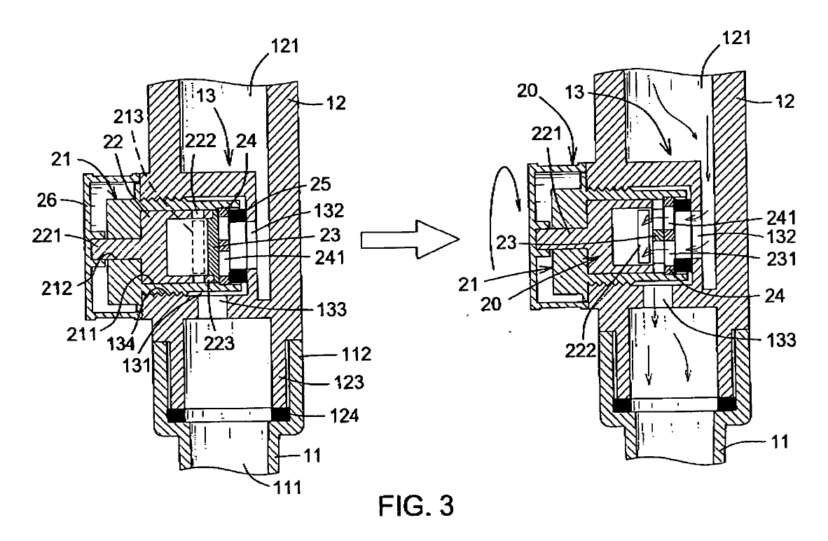

With reference to FIGS. 1 to 3, when the handheld bidet is not used, the blocking plate (23) of the valve (20) is in a position where the water flow is stopped from passing through the flow through holes (241) in the plate (24).

When the handheld bidet in accordance with the present invention is used, the user holds the handheld bidet in his/her hand. The knob (26) is rotated around the valve body (21) to turn the blocking plate (23). The flow through holes (241) in the plate (24) are uncovered allowing water to flow through. The water then sprays out of the through holes (34) in the cap (32) for washing. The lip (33) can be used to aid in cleaning.

The advantages of the handheld bidet in accordance with the present invention are as follows.

1. The handheld bidet may be connected to a toilet tank or a conventional faucet directly to provide water for cleaning. The user would not have to worry about water storage or contamination.

2. The design of the handheld bidet is simple and the bent distal end of the spray tube is ergonomic and convenient to use.

3. The volume and the speed of the water flow can be controlled by the user with the valve.

4. The lip formed on the cap provides an additional aid for cleaning.

5. The handheld bidet in the present invention is suitable for use in the home or anywhere that a convenient water source.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A handheld bidet comprising
a body having
a tubular body with
a bent distal end,
a proximal end,
a side wall, and
a fluid channel defined through the tubular body, and
a valve seat defined in the sidewall of the tubular body and communicating with the fluid channel in the tubular body;
a valve mounted inside the valve seat in the body to control water flow; and
a cleaning nozzle mounted on the bent distal end of the body having
an inner surface,
an outer surface,
a lip formed on the outer surface of the cleaning nozzle, and
multiple through holes defined in the cleaning nozzle.

2. The handheld bidet as claimed in claim 1, wherein the body has
a spray tube having
a distal end,
a proximal end, and
a channel defined through the spray tube; and
a handle tube connected to the spray tube and having
a distal end connected to the proximal end of the spray tube,
a proximal end,
a side wall, and
a fluid channel defined through the handle tube.

3. The handheld bidet as claimed in claim 2, wherein the proximal end of the spray tube is threaded onto the distal end of the handle tube, and a washer is mounted between the spray tube and the handle tube.

4. The handheld bidet as claimed in claim 3, wherein the valve seat is cylindrical and has
a side surface,
a cavity defined in the valve seat,
an inlet defined in the side surface of the valve seat and communicating with the fluid channel in the handle tube,
an outlet defined in the side surface of the valve seat and communicating with the fluid channel in the handle tube, and
a threaded end defined in the side surface and near the sidewall of the handle tube.

5. The handheld bidet as claimed in claim 4, wherein the valve mounted inside the handle tube has
a valve body mounted inside the valve seat and having an outer end,
a valve center rotatably mounted inside the valve body and having an inner end,
a blocking plate attached to the inner end of the switch center, a plate mounted at the inner end of the switch center, abutting with the blocking plate and having two flow through holes defined in the plate, and
a knob rotatably mounted on the outer end of the switch body.

6. The handheld bidet as claimed in claim 5, which the valve body mounted inside the valve seat further has
an inner end mounted inside the cavity in the valve seat,
an outer surface,
a cavity defined in the valve body at the inner end,
a through hole defined in the valve body at the outer end to communicate with the cavity, and
multiple fluid channels defined through the outer surface of the valve body.

7. The handheld bidet as claimed in claim 6, wherein
the valve body further comprises two engaging grooves defined in the inner surface of the valve body at the inner end and face each other, and the plate further comprises two locating studs formed on an edge corresponding to the engaging grooves in the valve body.

8. The handheld bidet as claimed in claim 7, wherein valve center mounted inside the valve body further has
an outer end,
an outer surface,
a rod formed on the outer end of the valve center,
an opening defined in the inner end of the valve center, and
multiple fluid channels defined respectively through the outer surface of the valve center corresponding to the fluid channels in the valve body.

9. The handheld bidet as claimed in claim 8, wherein
the valve center comprises two teeth formed at the inner end opposite to each other, and
the blocking plate comprises
an edge,
an inner surface being the surface facing the cavity in the valve center,
two breaches defined in the edge opposite each other, and
two grooves defined in the inner surface corresponding with the teeth on the valve center.

10. The handheld bidet as claimed in claim 9, wherein the valve further comprises a washer mounted between the valve seat and the plate.

11. The handheld bidet as claimed in claim 1, wherein the valve seat is defined as a cylinder and has
a side surface,
a cavity defined in the valve seat,
an inlet defined in the side surface of the valve seat and communicated the fluid channel in the handle tube,
an outlet defined in the side surface of the valve seat and communicated the fluid channel in the handle tube differing the inlet, and
a threaded end defined in the side surface and near the side wall of the handle tube.

12. The handheld bidet as claimed in claim 5, wherein
the valve body further comprises two engaging grooves defined in the inner surface of the valve body at the inner end and face each other, and
the plate further comprises two locating studs formed on the edge corresponding to the engaging grooves in the valve body.
